(19) United States
(12) Patent Application Publication
(10) Pub. No.: US 2012/0246619 A1
(43) Pub. Date: Sep. 27, 2012

(54) AUTOMATED TESTING OF BROWSER BASED RICH INTERNET APPLICATIONS (RIA) DELIVERED THROUGH PROPRIETARY FRAMEWORKS

(75) Inventors: Govindarajan Thirumalai, Bangalore (IN); Ohmkaar Kambhampati, Bangalore (IN); Manish Chauhan, Lakhimpur Kheri (IN)

(73) Assignee: Oracle International Corporation, Redwood Shores, CA (US)

(21) Appl. No.: 13/069,409

(22) Filed: Mar. 23, 2011

(51) Int. Cl. G06F 9/44

(52) U.S. Cl. 717/124

(57) ABSTRACT

Facilitating automated testing of browser based Rich Internet Applications (RIA) delivered through proprietary frameworks. According to one aspect, code modules of an RIA designed to not make user interface components accessible to an automated testing platform are modified by adding instructions such that the modified modules when executed makes the components accessible to the testing platform. The testing platform accordingly is enabled to access the data representing the components to check whether the performance of the RIA is according to an expected operation. According to another aspect, the different user interface components are made addressable by the testing platform by inserting unique values for an attribute common to all the components (as part of the modified modules). According to one more aspect, the modified modules are compiled along with a pre-defined set of libraries required to make the components accessible by the testing platform.

### BACKGROUND OF THE INVENTION

1. Technical Field

The present disclosure relates to Internet technologies, and more specifically to facilitating automated testing of browser based rich internet applications (RIA) delivered through proprietary frameworks.

2. Related Art

Browser refers to an application, which when executed on a digital processing system, enables users to access various content (such as audio, video, text, data, etc.) on the Internet using standard protocols such as HTTP and FTP as is well known in the relevant arts. The content is generally received from server systems accessible via the Internet in the form of respective web pages, and displayed to users.

The browser-content combination is designed to enable various types of user interactions such as clicking on a hyperlinked text (to request a corresponding web page), clicking on buttons to submit data, selection of options from a list, etc.). Examples of browsers include Internet Explorer™, Firefox™, and Chrome™ applications.

The early versions of the Browsers would typically reload (i.e., receive from server system and render the received content) the entire web page after many of the user interactions (e.g., selection of an option in a list, clicking on a button, selection of a link, etc.). The resulting user interface is not generally convenient in that it is not as seamless as with a ‘desktop’ interface on a personal computer type digital processing systems (where the content is rendered much faster since it is generated locally).

RIAs were introduced to overcome such disadvantages and provide a user experience that is closer to ‘desktop’ type interaction experience. In particular, RIAs are designed to avoid reload of the entire web pages to the extent possible. For example, if a user chooses USA as a country in one list, the corresponding states may be dynamically retrieved and populated in another list such that the user is shown only the retrieved list for further selection, without having to change rendering of the rest of the web page. In other words, the user can continue to view the web page and interact at least with some portions of the web page when retrieval/populations activities occur in the backend.

Frameworks are used to deliver such RIAs in the context of browsers. The framework provides functionality to retrieve the content asynchronous (in the background) with rendering of the web page. The effect of such functionality is to not change the display of the portions that would not be affected by the prior user actions. In the example of above, the list of states for the selected country (USA) is retrieved asynchronously and populated, such that the list is made available to the user when the state list is operated upon. The effect is that there is no unneeded changes to the display of the web page otherwise, thereby providing a user experience closer to a ‘desktop’.

There have been several non-proprietary frameworks (such as AJAX framework) provided in the context of browsers. The term ‘non-proprietary’ can be appreciated based on an understanding that browsers are implemented to interpret web pages having constructs compatible with commonly used client-side web technologies such as HTML, XHTML, XML, Javascript, CSS, etc., as is well known in the relevant arts.

When frameworks deliver RIAs consistent with such technologies, the framework is said to be non-proprietary. When such non-proprietary frameworks are used, the applications can be delivered through browsers without additional downloads/installations, etc., as is also well known in the relevant arts.

One advantage of using non-proprietary frameworks is that RIAs may be tested using automated testing approaches. In automated testing, a testing platform automatically sends a test input to a RIA (executing in the context of a browser) sought to be tested, determines (e.g., capturing the displayed screen output or accessing data exposed by the browser) a corresponding output (e.g., the state list loaded dynamically, as noted above), and then checks the determined output in comparison to an expected output.

A series of such sequence of steps (sending, determining and checking) are performed using a test script such that the RIA can be tested without manual intervention during testing. The non-proprietary nature of the framework enables the browser to expose the data corresponding to various components of the web page (e.g., visual elements such as buttons, lists noted above, etc.), which facilitates automated testing noted above.

Proprietary frameworks are often employed in the context of browsers, typically to deliver more complex or richer interactions. The proprietary frameworks are characterized in that additional software is generally installed and executed to process constructs that are not compatible with the technologies supported by the browser.

Accordingly browsers may be unable to facilitate automated testing of RIAs delivered through proprietary frameworks.

### BRIEF DESCRIPTION OF THE DRAWINGS

Example embodiments of the present invention will be described with reference to the accompanying drawings briefly described below.

FIG. 1 is a block diagram illustrating an example environment (computing system) in which several aspects of the present invention can be implemented.

FIG. 2 is a block diagram illustrating the manner in which a Rich Internet Application (RIA) is accessed, developed and tested in one embodiment.

FIG. 3 depicts a user interface provided by a RIA when executed in a framework operating in the context of a browser in one embodiment.

FIG. 4 is a flow chart illustrating the manner in which components of a user interface provided by a RIA are made accessible (to a testing platform) to facilitate automated testing of the RIA according to an aspect of the present invention.

FIG. 5 is a flow chart illustrating the manner in which components of a user interface provided by a RIA are made (uniquely) addressable to facilitate automated testing of the RIA according to an aspect of the present invention.

FIG. 6 is a block diagram illustrating the manner in which several features of the present invention for facilitating automated testing of a RIA are implemented in one embodiment.

FIGS. 7A and 7B together illustrates the manner in which the components of a user interface provided by a RIA are made (uniquely) addressable in one embodiment.

FIG. 8 is a block diagram illustrating the details of a digital processing system in which various aspects of the present invention are operative by execution of appropriate software instructions.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### 1. Overview

An aspect of the present invention facilitates testing of Rich Internet Applications (RIA). In one embodiment, code modules of a RIA are received from different developers, with the code modules being designed to provide various components of a user interface for the RIA. The received code modules are designed such that the user interface components are not accessible to an automated testing platform when the RIA is executed in a (proprietary) framework operating in the context of a browser. An automation tool then adds instructions to received code modules to generate modified modules, where the added instructions are designed to cause the user interface components to be made accessible to the automated testing platform when the RIA is executed in the framework in the context of the browser.

Accordingly, on executing the modified modules in the framework operating in the context of the browser, the user interface components are made accessible to the automated testing platform due to addition of the instructions. The automated testing platform is according enabled to access data representing the user interface components to check whether the performance of the RIA is according to an expected operation. Thus, automated testing of a browser based RIA delivered through a proprietary framework is facilitated.

According to another aspect of the present invention, automation tool also inserts a unique value for an attribute common to all the user interface components, thereby making the user interface components (uniquely) addressable by the automated testing platform. Such a feature enables testers and automated testing platform to (uniquely) identify specific user interface components to be tested.

According to one more aspect of the present invention, the modified code modules (containing the added instructions and/or the inserted unique values noted above) are compiled along with a pre-defined set of libraries required for making the components accessible to the automated testing platform. The executable modules (generated by such compilation) when executed during testing of the RIA causes the execution of the pre-defined set of libraries as well, thereby providing access to the user interface components to the automated testing platform.

Several aspects of the present invention are described below with reference to examples for illustration. However, one skilled in the relevant art will recognize that the invention can be practiced without one or more of the specific details or with other methods, components, materials and so forth. In other instances, well-known structures, materials, or operations are not shown in detail to avoid obscuring the features of the invention. Furthermore, the features/aspects described can be practiced in various combinations, though only some of the combinations are described herein for conciseness.

### 2. Example Environment

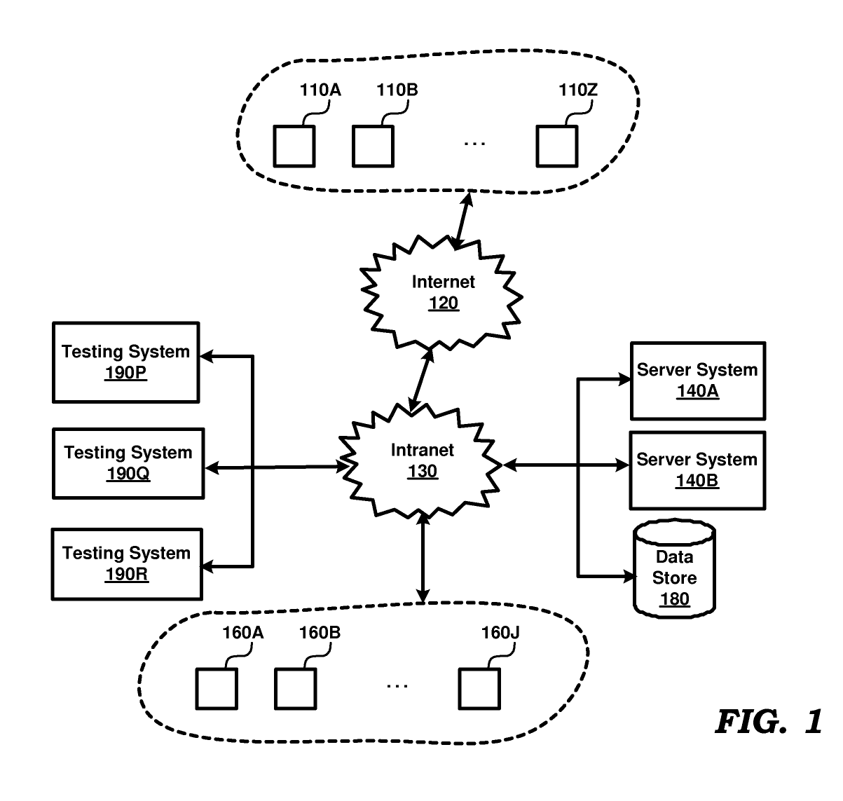

FIG. 1 is a block diagram illustrating an example environment (computing system) in which several aspects of the present invention can be implemented. The block diagram is shown containing end-user systems 110A-110Z, Internet 120, intranet 130, server systems 140A-140B, developer systems 160A-160J, data store 180 and testing systems 190P-190R.

Merely for illustration, only representative number/type of systems is shown in FIG. 1. Many environments often contain many more systems, both in number and type, depending on the purpose for which the environment is designed. Each system/device of FIG. 1 is described below in further detail.

Intranet 130 represents a network providing connectivity between server systems 140A-140B, developer systems 160A-160J, data store 180 and testing systems 190P-190R all provided within an enterprise. Internet 120 extends the connectivity of these (and other systems of the enterprise) with external systems such as end-user systems 110A-110Z.

Each of intranet 130 and Internet 120 may be implemented using protocols such as Transmission Control Protocol (TCP) and/or Internet Protocol (IP), well known in the relevant arts. In general, in TCP/IP environments, an IP packet is used as a basic unit of transport, with the source address being set to the IP address assigned to the source system from which the packet originates and the destination address set to the IP address of the target system to which the packet is to be eventually delivered. An IP packet is said to be directed to a target system when the destination IP address of the packet is set to the IP address of the target system, such that the packet is eventually delivered to the target system by Internet 120 and intranet 130. When the packet contains content such as port numbers, which specifies the target application, the packet may be said to be directed to such application as well.

Each of end-user systems 110A-110Z represents a system such as a personal computer, workstation, mobile station, etc., used by end users to generate (user) requests directed to business/enterprise applications executing in server systems 140A-140B. The requests may be generated using appropriate user interfaces. In general, an end-user system requests an application for performing desired tasks and receives corresponding responses containing the results of performance of the requested tasks. Each request is sent in the form of an IP packet directed to the desired server system, with the IP packet including data identifying the desired tasks in the payload portion.

Data store 180 represents a non-volatile (persistent) storage facilitating storage and retrieval of a collection of data by business/enterprise applications executing in server systems 140A-140B. Data stores 180 may be implemented as a database server using relational database technologies and accordingly provide storage and retrieval of data using structured queries such as SQL (Structured Query Language). Alternatively, data store 180 may be implemented as a file server providing storage and retrieval of data in the form of files organized as one or more directories, as is well known in the relevant arts.

Each of server systems 140A-140B represents a server, such as a web/application server, executing business/enterprise applications capable of performing tasks requested by end users using one of end-user systems 110A-110Z. A server system may perform the tasks on data maintained internally or on external data (e.g., stored in data store 180) and then send the result of performance of the tasks to the requesting client system.

Each of developer systems 160A-160J represents a system such as a personal computer, workstation, mobile station, etc., used by users/developers to create and/or modify some of the code modules forming a business/enterprise application. In a common scenario, the developers create new code modules and store the modules in a code repository (e.g. provided in data store 180). The stored code modules forming the business application are then deployed (in a state ready for processing user requests received from end-user systems) on server systems 140A-140B. In one embodiment, the stored code modules are compiled (converted from instructions specified in a programming language in which the code modules are created to an executable form) before deployment on the server systems.

Each of testing systems 190P-190R represents a system such as a personal computer, workstation, mobile station, etc., used by users/testers to test (and/or verify) whether the performance of the business/enterprise applications deployed on server systems 140A-140B are according to expected operation (e.g., based on a functional/operational specification according to which the business application was developed). In general, a testing system provides an environment similar to one or more of the end-user systems (110A-110Z) to facilitate the tester to verify whether the user interfaces as provided to an end-user (and also the corresponding tasks performed by the business application in response to user requests) are according to the expected operation.

Thus, developers using developer systems 160A-160J create new business applications and deploy the applications on server systems 140A-140B, and testers thereafter using testing systems 190P-190R test and verify the deployed applications. The applications approved (after testing) may then be made available to the end users to enable them to send requests for performing desired tasks using end-user systems 110A-110Z. In an alternative embodiment, the deployed applications are made available to the end users before approval, with the testers and end users accessing the deployed application simultaneously.

It may be appreciated that some of the business applications may be browser based Rich Internet Applications (RIA) that are delivered to the end users through proprietary frameworks. As noted above in the Background section, there are several challenges to the automated testing (in particular, automated testing) of such RIAs. The challenges may be better appreciated by understanding the manner in which RIAs are accessed, developed and tested. The manner in which RIAs are accessed in first described below with examples.

### 3. Accessing RIAs

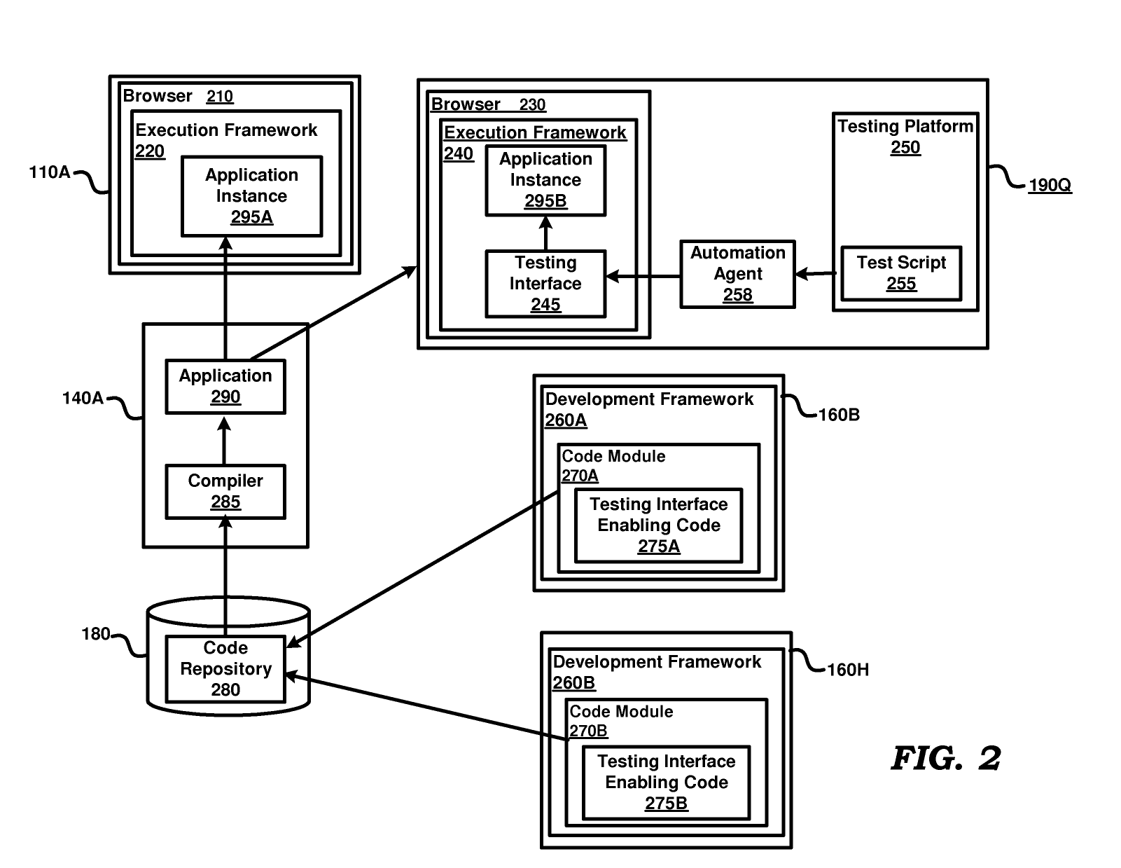

FIG. 2 is a block diagram illustrating the manner in which a Rich Internet Application (RIA) is accessed, developed and tested in one embodiment. Merely for illustration, only representative number/type of systems is shown in FIG. 2. Many environments often contain many more systems, both in number and type, depending on the purpose for which the environment is designed. Each of the systems/blocks of FIG. 2 is described in detail below.

Browser 210 (executing in end-user system 110A) facilitates end-users to access various content (such as audio, video, text, data, etc.) in the form of web pages over Internet 120. Execution framework 220 represents a proprietary framework operating in the context of browser 210, and facilitates delivery of RIAs to the end users. The phrase “operating in the context of the browser” implies that the operation of execution framework 220 is constrained in several operational aspects in one or more display features (e.g., the user interface of applications executed by the framework are provided within the window or user interface of the browser), configuration settings (i.e., what is configured associated with the browser is applicable to the operation of the framework), etc. For example, with respect to Adobe Flash Player operating in the context of Internet Explorer™ noted below, both the display features and the configuration settings are applicable to the operation of the framework. In addition, the framework may require low level functionalities such as TCP sessions to be provided by the browser.

In one embodiment, additional software designed to provide execution framework 220 is installed prior to delivering the RIAs, and an association between the execution framework and specific “objects” embedded in web pages is maintained by browser 210. The embedded “objects” contain instructions that are understood by the execution/proprietary framework, but not by browser 210. In other words, browser 210 is unable to present the content represented by the embedded “object” to the end user. Accordingly, browser 210, on determining that such an “object” is present in a web page sought to be displayed, starts execution of execution framework 220 and passes the (instructions constituting the) embedded “object” to execution framework 220 for presentation to the end user.

Adobe Flash Player available from Adobe System Inc. represents an execution framework capable of presenting RIAs (“Flash” applications) based on Adobe Flash™ platform (a proprietary platform of Adobe Systems Inc). The RIAs are typically in the form of “Flash” objects (“SWF” files) embedded in a web page. The Adobe Flash Player is installed as additional software to the browser, for example, as ActiveX controls or browser helper objects (BHOs) when the browser is Internet Explorer™ available from Microsoft Corporation. On identifying that “Flash” objects/“SWF” files are embedded in the web page, the browser invokes the flash player ActiveX control/BHO to present the content of the SWF file to the end user.

Application instance 295A represents an instance of a RIA delivered in the form of such proprietary embedded objects, and is accordingly shown executed by execution framework 220 operating in the context of browser 210. On execution of the instructions constituting the application instance 295A, a corresponding user interface is presented to the end users.

An end user using end-user system 110A may perform various types of interactions, such as clicking a button, selecting options from a list, etc., with the user interface provided by application instance 295A. Some of the interactions may cause user requests to be sent to backend systems such as server system 140A, receive corresponding responses and update the user interface, without reloading the entire web page.

Application 290 represents a business/enterprise browser based rich internet application (RIA) deployed on server system 140A. Application 290 may be deployed in the form of “Flash” objects embedded in web pages served by server system 140A. Thus, browser 210 may request for the specific web pages in which application 290 is embedded and receive the instructions constituting the application as corresponding response. Browser 210 may then execute the received instructions using execution framework 220 to provide application instance 295A (an instance of execution of application 290). An example user interface of an RIA (such as application instance 295A) is described below with examples.

### 4. Example User Interface of an RIA

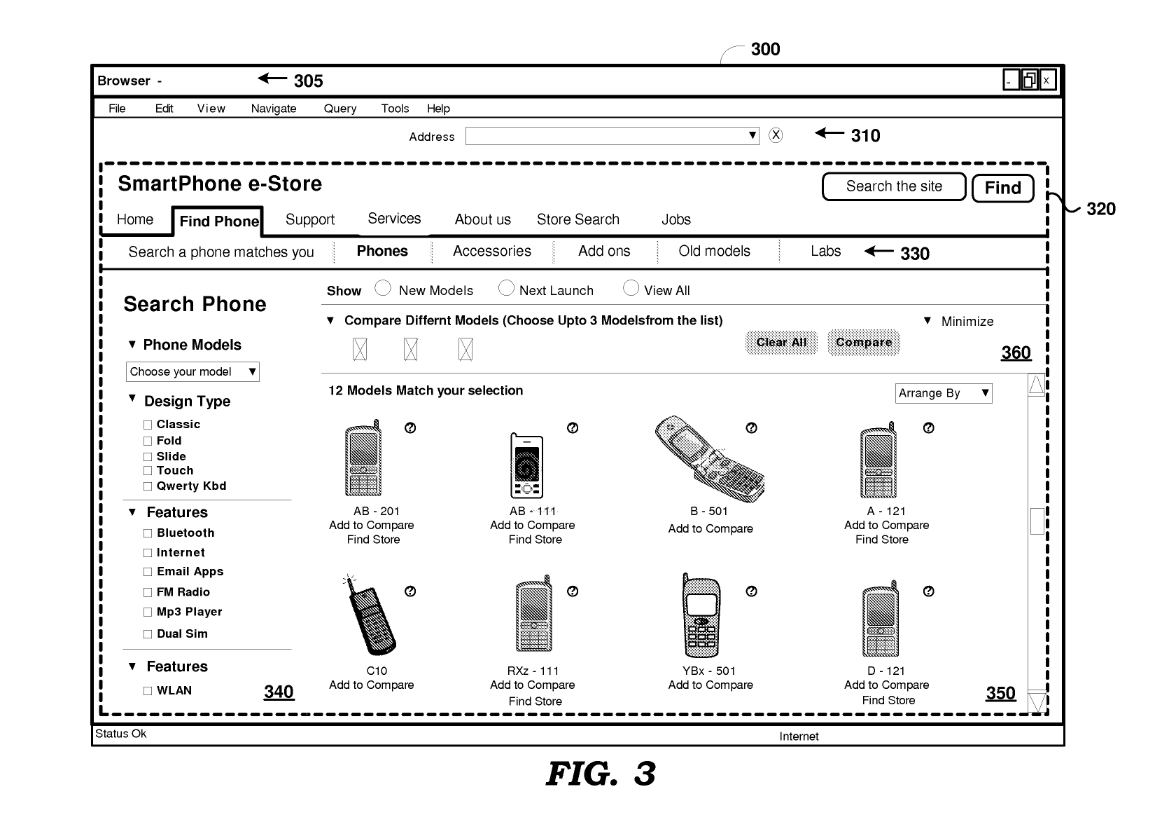

FIG. 3 depicts a user interface provided by a rich internet application (RIA) when executed in a framework operating in the context of a browser in one embodiment. Display area 300 depicts a portion of a user interface displayed on a display unit (not shown) associated with an end-user system (such as 110A). Display area 300 corresponds to the display provided by a browser (such as 210, as indicated by the text 305), in response to a user accessing the web page at “http://www.acmephonestore.com” (as indicated by text 310), for example, to view, compare and/or purchase mobile phones.

Display area 320 represents a user interface provided by an instance of a RIA (such as application instance 295A) when executed by a proprietary framework (such as execution framework 220) in the context of the browser. As noted above, display area 320 may be provided by a “Flash” application when executed by the Adobe Flash Player in the context of Internet Explorer browser.

Each of the visual elements such as buttons, check boxes (in display area 340), images of phones and links (in display area 350), radio buttons, etc. and layout elements such as horizontal/vertical lines used to mark the display areas, menu items (in display area 330), etc., may be viewed as a component of the user interface. Only a few components of interest are described below for conciseness.

Checkboxes 341-344 enable a user to view phones that match specific criteria. For example, a user may select checkbox 343 to view only phones that have “Bluetooth” technology. The selection of a checkbox in display area 340 causes display area 350 to be reloaded with only the phones that match the selected criteria. Such reloading of display area 350 is performed without reloading of the entire web page (or other portions of the display interface provided by the RIA).

A user may click on the “?” (question mark) link (such as 354) shown on top of each phone to view a brief summary of the phone. The summary of the phone is then displayed as a pop-up overlaid on display area 350, again without reloading of the entire webpage/display area 320. A user may click on the links labeled “Add to Compare” (such as 357) to add the desired phones to display area 360 (again without reloading the entire web page), and then click on the “Compare” button to compare the added phones shown in display area 360.

Each of the above noted interactions (such as the user clicking on checkbox 343, clicking on the question mark link, etc.) may cause user requests to be sent (asynchronously) to backend servers such as server systems 140A for performing specific tasks (e.g., to get a list of phone matching the selected criteria/checkboxes in display area 340), to receive the results (e.g, the list of phones) of performance of the tasks, and to update the user interface without reloading the entire webpage (e.g., display area 350).

Thus, user interface 320 provided by application instance 295A (an instance of the application 290) operates as a rich internet application that provides a user experience closer to a “desktop”. The manner in which a RIA (such as application 290) may be developed by developers using developer systems 160A-160J is described below with examples.

### 5. Developing RIAs

Referring again to FIG. 2, development framework 260A represents an application that facilitates developers to create/modify code modules forming a rich internet application (RIA), such as application 290. An example development framework is Adobe Flex available from Adobe Systems Inc, which enables developers to create RIAs (“Flash” applications) based on Adobe Flash™ platform noted above.

Thus, developers using the development frameworks 260A and 260B (executing respectively on developer systems 160B and 160H) create code modules such as 270A and 270B containing instructions (e.g., according to the Adobe Flash platform) forming the RIA. The developers may then store (commonly referred to as “check-in”) the code modules 270A-270B in code repository 280 (provided in data store 180). Other developers (not shown) may similarly check-in other code modules constituting the RIA into code repository 280.

In general, the instructions constituting the code modules are designed to provide components of a user interface (presented to the user, as described above with respect to FIG. 3) on execution by execution framework 220/240. Other instructions may be designed to send (asynchronously) user requests to backend servers (such as server system 140A) for performing specific tasks in response to specific user interactions, to receive the results of performance of the tasks, to update the user interface without reloading the entire webpage, etc. The code modules may also include instructions to perform other complex programming logic as desired by the developers.

In one embodiment, the code modules contain instructions according to extended markup language (XML) that can be executed by execution framework 220. It may be appreciated that though the code modules contain XML constructs that can be understood by browsers (such as 210), such understanding may only be at the syntax level (the form of the construct) and not at the semantic level (the specific meaning and/or action to be performed for the construct). Only the execution frameworks (such as 220) operating in the context of the browsers may be designed to understand the constructs at the semantic level, and to perform the corresponding actions indicated by the constructs.

Compiler 285 retrieves the code modules (such as 270A-270B) that have been checked into code repository 280 and compiles the instructions in the code modules to generate application 290. As noted above, compilation of the instructions may involve converting instructions specified in a programming language in which the code modules are created (by developers using developer systems such as 160B or 160H) to an executable form, suitable for execution by execution framework 220/240. In above noted embodiment, compiler 285 may merely bundle all the code modules containing the XML instructions together with other library modules needed for execution to form application 290.

For simplicity, in the following description, it is assumed that application 290 includes instructions for providing a user interface (such as, shown in FIG. 3) and also instructions implementing the underlying programming logic to be performed in response to user interactions (that is, for processing user requests asynchronously from the user interface). Thus, application 290 is executing in a single server system (140) for providing the various features of a RIA.

However, it may be appreciated that in alternative embodiments, application 290 may represent one (in particular, a block providing a user interface) of a set of application blocks forming part of a complex application, for example, designed according to Service Oriented Architecture (SOA). The various application blocks may be deployed on multiple server systems (a distributed architecture), with each application instance 295A/B (of the corresponding application block 290) containing the details of the respective application blocks/server systems to which specific user requests are to be sent (from the user interface). Furthermore, compilation of such complex applications may be performed (in one or more server systems) using build tools, such as a Maven, Hudson, etc. well known in the relevant arts.

Thus, different developers co-ordinate together to create code modules forming a RIA, which are then compiled (by compiler 285) and deployed (as application 290) on server system 140A. The manner in which such deployed RIAs are tested is described below with examples.

### 6. Testing RIAs

Referring again to FIG. 2, testing system 190Q facilitates testers to test RIAs such as application 290 deployed on server system 140A. Testing system 190Q provides an environment similar to end-user system 110A to enable the testers to verify whether the performance of application 290 when executed by a framework (220) in the context of a browser (210) on end-user system 110A, is according to expected operation. Thus, testing system 190Q is shown executing browser 230 and execution framework 240 that are respectively similar to browser 210 and execution framework 220 executing in end-user system 110A.

Application instance 295B represents an instance of application 290 provided by execution framework 240 operating in the context of browser 230 in testing system 190Q. Application instance 295B may be provided similar to how application instance 295A is provided by execution framework 220 operating in the context of browser 210, and accordingly, the description is not included here for conciseness. Thus, application instance 295B is similar to application instance 295A and testing and verification of the performance of application instance 295B is sufficient to ensure that application instance 295A performs according to the expected operation.

Testing platform 250 facilitates testers to check whether application instance 295B is performing according to expected operation. In one approach, testing platform 250 enables a tester to perform a specific interaction (manually) with the user interface provided by application instance 295B, to capture the changes to the user interface or the output of the task performed by the application in response to the interaction, and to compare the captured changes/output with an expected output (pre-determined based on a design specification for the application). Such a manual approach may not be feasible when a large number of interactions are to be tested (as is typically the case with enterprise applications).

Accordingly, testing platform 250 also facilitates users to perform automated testing of RIAs such as application instance 295B. In automated testing, testing platform 250 automatically sends a test input to application instance 295B sought to be tested (thereby mimicking the manual interaction performed by the tester), determines (e.g., capturing the displayed screen output or accessing data exposed by the browser) a corresponding output of the interaction, and then checks the determined output in comparison to an expected output (provided earlier by a testing group). Such automated testing may be facilitated by automation agent 258 shown operating between testing platform 250 and execution framework 240. In general, automation agent 258 facilitates communication between a testing platform and a proprietary framework such as Adobe Flash Player.

In a common scenario, testing platform 250 receives from the tester a series of sequence of steps (sending, identifying and checking) to be performed for testing an RIA in the form of a test script. Test script 255 represents one such sequence of steps to be performed for testing application instance 295B. Such test scripts enable testing platform 250 to test the RIA (by using automation agent 258) without manual intervention during testing. Though in the following description, testing platform 250 is described as performing automated testing, it should be appreciated that all such automated testing is facilitated by automation agent 258. An example for such an automated testing platform is HP (formerly) Mercury QuickTest Professional (QTP) available from Hewlett-Packard Company. The corresponding automation agent is a QTP-Flash/Flex plug-in provided by Adobe Systems Inc, which facilitates communication between QTP and Flash Applications.

It may be appreciated that the steps of sending the inputs and determining the output necessitates that the data corresponding to the various components forming the user interface (e.g., visual elements such as buttons, lists, etc., layout elements such as tabs, groups, etc.) be made accessible to testing platform 250. The term “accessible” implies that the components are recognizable (e.g., in terms of “what” the testing platform 250 understands, uniquely identifiable by a corresponding name, etc.) and that the data (such as attributes, events, etc.) associated with the components can be read and/or changed by testing platform 250.

Browsers (such as 230) are generally designed to expose the various components of the web pages to testing platform 250. Exposing a component implies that the values/structure of the component is made accessible/available, for example, by appropriate APIs. In other words, when a component is not exposed, external programs may be unable to access (programmatically using software instructions) the unexposed detail. Thus, when the components of a web page are exposed, automated testing of the web pages is facilitated. Browsers are generally not capable of exposing several of the components provided by a RIA (that require frameworks for execution).

In some scenarios where the RIAs are delivered through non-proprietary frameworks (where the instructions forming the RIAs are consistent with the client-side web technologies understood by the browser), the non-proprietary nature of the framework enables the browser to expose the various components of the RIA thereby facilitating automated testing of the RIA. However, the browser alone is unable to expose the components of RIAs delivered through proprietary frameworks (such as Adobe Flash™, noted above).

In one embodiment, automated testing of RIAs delivered through proprietary frameworks is facilitated by the execution framework (220/240) executing the RIA. The execution framework provides a testing interface through which a testing platform is enabled to access the components of the RIA and to perform steps of sending and determining specified in the test script.

Testing interface 245 represents one such interface provided by execution framework 240 to facilitate testing platform 250 to perform automated testing of application instance 210. Testing interface 245 typically contains library modules that are bundled along with the code modules (by compiler 285) to form application 290. The library modules are generally made available as application programming interfaces (APIs) that can be invoked by testing platform 250, when executing test script 255. However, there are several scenarios where the library modules are not sufficient to facilitate automated testing.

For example, it may be desirable that specific custom attributes and/or events associated with composite/custom components be exposed to testing platform 250. A composite component is formed by combining one or more basic components provided by the proprietary framework. The developers of the application commonly create (from basic components) and/or use composite components specific to each application. Thus, though the library modules (forming testing interface 245) may expose the basic components to testing platform 250, the burden of exposing custom attributes/events of composite/custom components may fall on the developers. The developers may be required to add instructions according to a pre-defined format for exposing composite components.

As another example, it may be desirable that each of the components in the user interface be uniquely addressable (accessed using a unique identifier). Such a feature may facilitate a tester to indicate the desired specific components to be tested in test script 255 and also facilitate testing platform 250 to correspondingly access and perform the steps of sending inputs/determining outputs for the specific components specified in the test script 255. Accordingly, it may be required that developers add data indicating a unique address/identifier for each of the components in the user interface provided by application 290.

It may be appreciated that though components made accessible to the testing platform are generally also addressable by the testing platform, there are several scenarios where the feature of such unique addressability of each component may still be desirable. For example, button components are generally addressed using the values (e.g., “OK”, “Cancel”, “Save”, etc.) of the “label” attribute present in the components. However, in the scenario that the values of the label attribute are modified dynamically (e.g., from “Save” to “Save Later”) by execution of the instructions in the application, the testing platform may be unable to address the specific button components due to change in the name/label of the component.

Thus, developers are required to include specific data/instructions to the code modules forming the RIA to facilitate automated testing of the RIA. The library modules (forming testing interface 245) are designed to operate with data/instructions included by the developers of the application in facilitating automated testing. It may be appreciated that the data/instructions to be included in the code modules are generally optional, and do not affect the normal operation of the application.

For example, for the Adobe Flash™ proprietary framework, developers are required to add (optional) data/instructions according to the best-practices document titled “Adobe Flex*2: Using the Automated Testing API” available from Adobe Systems Inc., to facilitate testing platforms (such as QuickTest Professional, noted above) to perform automated testing of the corresponding RIAs. In general, the included optional data/instructions enable the testing platform to uniquely identify (recognize) each of the components in the UI of the application, to access created by the developers, etc.

Testing interface enabling code 275A and 275B represents data/instructions that are included by developers of a RIA, to facilitate automated testing of the RIA. For example, testing interface enabling code 275A and 275B may contain (optional) data/instructions consistent with the above noted best-practices document such as unique identifiers for each component, additional code to facilitate access to custom/composite components, etc. that enables application 290 (a Flash Application) to be tested in an automated manner using testing platform 250 (e.g., QuickTest Professional).

It may be appreciated that that requirement on the developers to add specific data/instructions for automated testing has several challenges. One challenge is that enterprise applications are generally developed by a large number of developers (that may be organized as several teams) located at different geographical locations, and accordingly, ensuring that the above requirement is met by all the developers of the application may not be feasible. For example, it may not be feasible that the large number of developers/teams agree to and systematically use a common format for generating unique identifiers for each of the components in the user interface of the RIA (in particular, since the number of user interface components can be very large, e.g., in the order of 10000+).

Another challenge is that the non-inclusion of the specific data/instructions can be detected only during the testing phase of the application (and not during compilation by compiler 285), and it may not be feasible to modify the code modules (for adding the optional data/instructions) at this stage of the application development. The non-inclusion of the optional data/instructions may be due to reasons such as lack of knowledge of the developers regarding the above requirement, the overhead cost for the addition of the optional data/instructions, etc. In one embodiment, the non-inclusion of library modules required for facilitating automated testing during compilation of the application (by compiler 285) causes testing interface 245 to be not present in testing systems 190Q, thereby impeding automated testing of the application.

Several aspects of the present invention facilitate automated testing of browser based RIAs (such as application 290) delivered through proprietary frameworks (such as Adobe Flash™ platform). The description is continued illustrating the manner in which components of a RIA are made accessible to facilitate automated testing, followed by the manner in which components of a RIA are made addressable to facilitate automated testing.

### 7. Making Accessible Components to Facilitate Automated Testing of a RIA

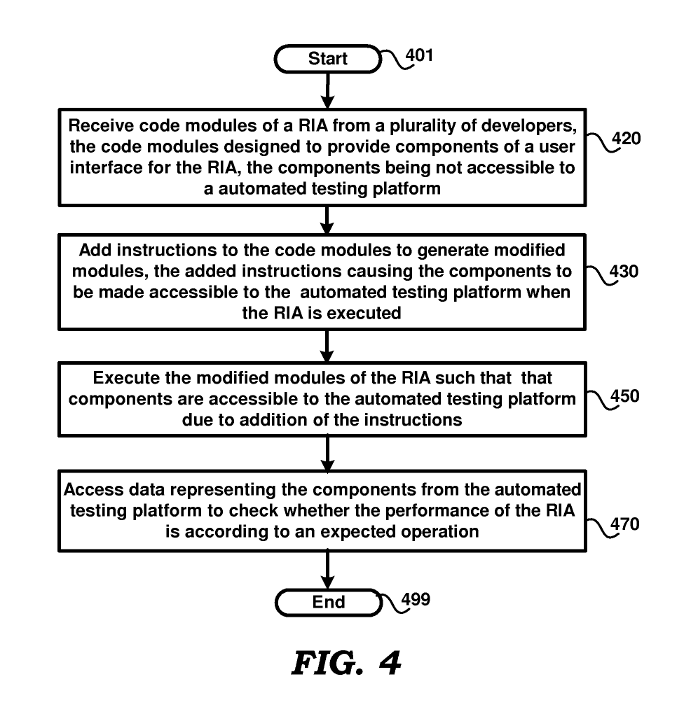

FIG. 4 is a flow chart illustrating the manner in which components of a user interface provided by a rich internet application (RIA) are made accessible (to a testing platform) to facilitate automated testing of the RIA according to an aspect of the present invention. The flowchart is described with respect to FIGS. 1, 2 and 3 merely for illustration. However, many of the features can be implemented in other environments also without departing from the scope and spirit of several aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 401, in which control immediately passes to step 420.

In step 420, code modules of a RIA are received from developers with the code modules designed to provide components (such as those shown in FIG. 3) of a user interface for the RIA, with the components being not accessible to a automated testing platform (such as testing platform 250) in the form coded in the received modules. The code modules may be received from developer systems 160A-160J and checked into (stored in) code repository 280.

It may be appreciated that the components provided by the code modules are not accessible by the testing platform, since the (optional) data/instructions (as represented by testing interface enabling code 275A/275B) that are required to be added to make them accessible has not been included by the developers in the checked-in code modules. In other words, testing interface 245 is unable to provide access to the components of the RIA, and accordingly automated testing of the RIA formed from these modules cannot be performed.

In step 430, instructions are added to the code modules to generate modified modules, the added instructions causing the components to be made accessible to the automated testing platform (250) when the RIA (application instance 295B) is executed by the framework (240) in the context of a browser (230). For example, for “Flash” applications, the newly added instructions may be consistent with the best-practices document noted above.

In the example noted above, instructions according to the pre-defined format for exposing the custom attributes/events of composite components created and/or used by the developer of the application may be added to the code modules (checked-in by the developers). The addition of such instructions enables the composite components to be made accessible (using testing interface 245) to the testing platform, and accordingly facilitate automated testing of the RIA.

In step 450, the modified modules of the RIA are executed such that the components are made accessible to the automated testing platform due to addition of the instructions. As noted above, the modified modules may be first compiled into the RIA, before execution in one of the testing systems. The added instructions when executed in testing system 190Q enable testing interface 245 to expose the components to testing platform 250.

In step 470, data representing the components is accessed from the automated testing platform (250) to check whether the performance of the RIA (application instance 295B) is according to an expected operation (as specified by a design specification for the application). The flow chart ends in step 499.

Thus, the developers of the RIA are relieved of the burden of manually adding the specific instructions for exposing components of the RIA (that are normally not accessible without inclusion of the specific instructions).

The manner in which components of a RIA are made addressable to facilitate automated testing is described below with examples.

### 8. Making Components Addressable to Facilitate Automated Testing of a RIA

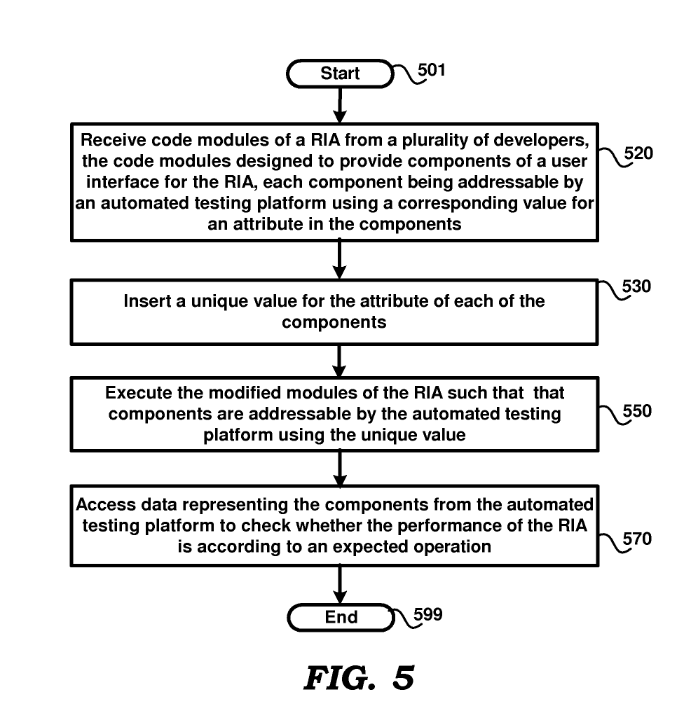

FIG. 5 is a flow chart illustrating the manner in which components of a user interface provided by a rich internet application (RIA) are made (uniquely) addressable to facilitate automated testing of the RIA according to an aspect of the present invention. The flowchart is described with respect to FIGS. 1, 2 and 3 merely for illustration. However, many of the features can be implemented in other environments also without departing from the scope and spirit of several aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 501, in which control immediately passes to step 520.

In step 520, code modules of a RIA are received from developers with the code modules designed to provide components (such as those shown in FIG. 3) of a user interface for the RIA, each component being (uniquely) addressable by an automated testing platform (such as testing platform 250) using a corresponding value for an attribute in the components. The code modules may be received from developer systems 160A-160J and checked into (stored in) code repository 280.

It may be appreciated that the components provided by the code modules are not uniquely addressable by the testing platform, since the developers have not specified any values for the attribute. In other words, testing interface 245 is unable to make the components of the RIA uniquely addressable, and accordingly automated testing of the RIA formed from these modules may not be possible to be performed.

In step 530, a unique value is inserted for the attribute of each of the components, thereby making the components uniquely addressable. The addition of the unique value for the attribute ensures that the components of the RIA are addressable to the automated testing platform (250) when the RIA (application instance 295B) is executed by the framework (240) in the context of a browser (230). For example, for “Flash” applications, the newly added unique values may be inserted for an attribute indicated by the best-practices document noted above. Thus, the addition of unique values facilitates automated testing of the RIA.

In step 550, the modified modules of the RIA are executed such that the components are addressable by the automated testing platform using the unique value. In step 570, data representing the components is accessed from the automated testing platform (250) to check whether the performance of the RIA is according to an expected operation. The steps of 550 and 570 may be respectively performed similar to steps 450 and 470 described above. The flow chart ends in step 599.

Thus, the developers of the RIA are relieved of the burden of manually adding the specific data for exposing components of the RIA to facilitate automated testing of the RIA. The manner in which the steps of FIGS. 4 and 5 may be implemented is described below with examples.

### 9. Example Implementation

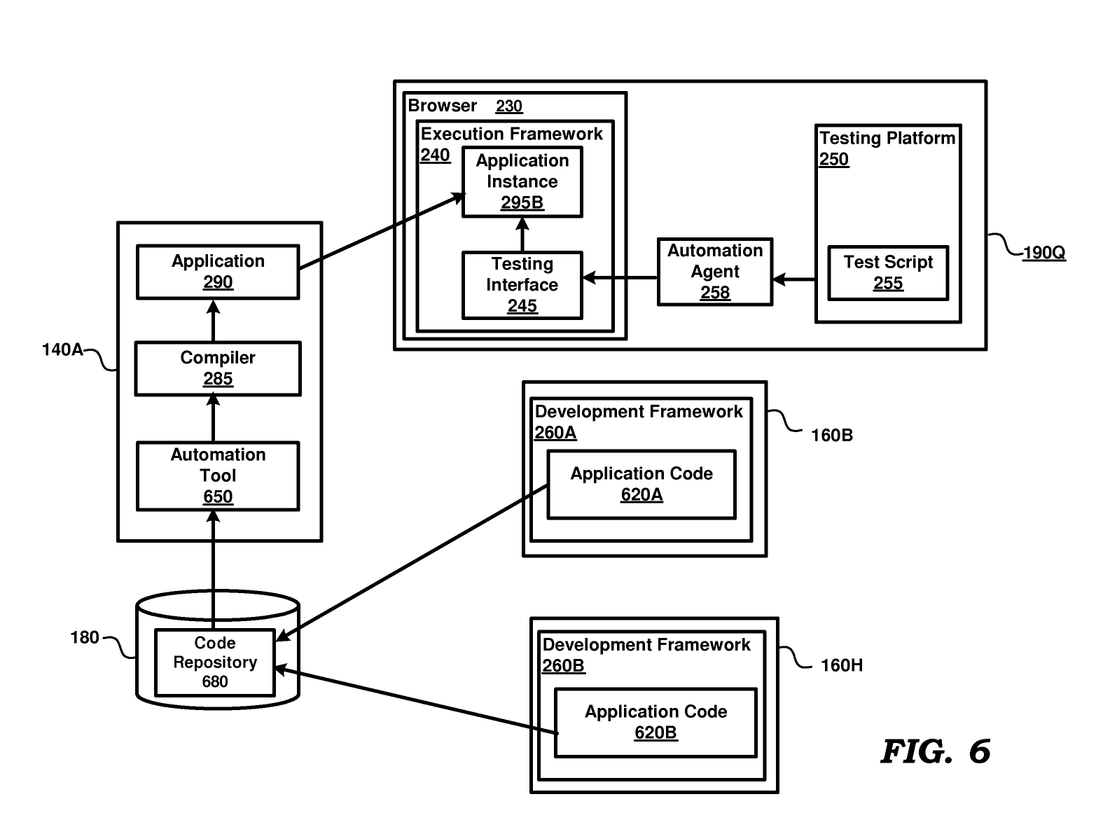

FIG. 6 is a block diagram illustrating the manner in which several features of the present invention for facilitating automated testing of a rich internet application (RIA) are implemented in one embodiment. Similar numbers are used to represent corresponding portions of FIGS. 2 and 6 and hence descriptions of such portions are not repeated for conciseness.

Each of code modules 620A-620B contains instructions provided by developers of the RIA (application 290) similar to code modules 270A-270B of FIG. 2. However, code modules 620A-620B do not contain the optional data/instructions (as represented by testing interface enabling code 275A-275B) required to facilitate automated testing of the application. Thus, code modules 620A-620B, as checked into code repository 680, if compiled into an RIA (in place of 290) causes the components of the users interface provided by the RIA to be not accessible to the automated testing platform (250).

Code repository 680 contains the set of code modules forming application 290 that do not contain the optional data/instructions noted above. In other words, the code in code repository 680 does not contain either the optional instructions to make accessible the components of the RIA or the optional data (unique identifiers) to make addressable the various components of the RIA.

Automation tool 650, provided according to several aspects of the present invention, adds the optional data and instructions required to facilitate automated testing of the RIA (application 290). For example, automation tool 650 is designed to add instructions consistent with the best-practices document noted above to make accessible the (composite) components of the RIA, and also to insert data (unique identifiers) consistent with the best-practices document noted above to make addressable the components of the RIA.

Automation tool 650 adds/inserts the instructions/data in the code modules retrieved from code repository 680 to generate modified code modules, which when compiled and executed facilitates automated testing. Automation tool 650 is also designed to compile the modified code modules with the library modules forming testing interface 245, thereby ensuring that automated testing of the RIA (application instance 295A) can be performed.

The manner in which automation tool 650 adds instructions/data to a “Flash” application (developed using the Adobe Flash™ proprietary framework) consistent with the best practices document for the framework noted above is described below with examples.

### 10. Facilitating Automated Testing of a Flash Application

According to an aspect of the present invention, automation tool 650 adds instructions to make accessible custom attributes/events of custom/composite components of a Flash RIA. The specific instructions added to make accessible a custom component named ““CSPMenuButton” is described below. Various references to classes and other constructs of Flash are described in a document entitled, “Adobe Flex 2, Using the Automated Testing API”, available from Adobe Systems.

Custom component/class CSPMenuButton extends the basic component Button (provided by the Flash framework) and as such inherits all button action listeners (events). All the events of the basic component Button are accessible to automated testing platform (250). However, the CSPMenuButton class also encloses a list of Menultems (another basic component provided by the Flash framework), which is instantiated as follows (shown in the form of Action Script™ like pseudo-code):

```
    Static public function addMenuItemTo (items: Array, label: String,
enabled: Boolean =true, action: Function = null): Object
    {
        Var menuItem:Object = {label: label, enabled: enabled};
        If (action! = null) menuItem.action = action;
        Items.push (menuItem);
        Return menuItem;
    }
```

In general, custom/composite components have various kinds of events associated with them based on individual components from which they are composed. Testing platforms such as QTP are generally not capable of distinguishing whether a response event is to be delegated to individual component or a custom/composite component and also whether the event is emerging from individual component or custom/composite component. Accordingly, testing platforms typically do not respond to any event executed on/emerging from custom components. Thus, the events corresponding to the click of each MenuItem component in the list is not identified by the testing platform, and automated testing of the application containing the above custom/composite component is not possible.

Automation tool 650 is designed to receive a list of custom components (from developers), determine the code/instructions constituting the received custom components and add appropriate instructions for enabling automated testing (consistent with the Flash best-practices document noted above). For example, automation tool 650 may add instructions such that the CSPMenuButton class/component has event listeners on both ButtonClick (corresponding to MenuShow, showing of the all the Menultems in the list) and MenuClick (corresponding to a click on a menu item in the list) events and that (custom events) can be accessed by the testing platform.

Automation tool 650 may accordingly first add instructions for an Event class with all the customer events that are to be made accessible to the testing platform 250. The instructions that may be added is shown below (again in the form of Javascript like pseudo-code):

```
    package oracle.sysman.csp.flex.common
    {
      import flash.events.Event;
      import mx.controls.Label;
      import mx.events.*;
      public class CustomMenuObjEvent extends Event
      {
        public var itemRenderer:Label;
        public var itemRendererName:String;
        public static const ITEM_CLICK:String = “itemClick”;
        public static const MOUSE_CLICK:String= “mouseClick”;
        public function CustomMenuObjEvent(type:String,
bubbles:Boolean=false, cancelable:Boolean=false)
        {
            super(type, bubbles, cancelable);
        }
        public function set_itemRenderer(custComponent:Label,
        label:String):void{
            this.itemRenderer= custComponent;
            this. itemRendererName= label;
        }
      }
    }
```

It may be observed that the event class “CustomMenuObjEvent” defines constants ITEM_CLICK and MOUSE_CLICK corresponding to each event generated by the custom component CSPMenuButton.

Automation tool 650 may then add instructions for a Delegate class “CustomMenuObjDelegate” that implements the required interfaces. The delegate class is designed to extend the UIComponentAutomationImpl class, and is marked as a mixin by using the [Mixin] metadata keyword. The delegate class is registered with the Automation Manager (forming part of testing interface 245) by calling the AutomationManager.registerDelegateClass ( ) method in the init ( ) method of the delegate class.

A value is defined for the automationName and/or the automationValue attributes used by the testing platform to uniquely address the custom components of the RIA. Furthermore, in the constructor the delegate class, instructions for event listeners for the events that the automated testing platform (250) is designed to record is added. Also, instructions are added to override the method replayAutomatableEvent( ) which is invoked by the Automation Manager for replaying events.

Automation tool 650 may also add instructions to the custom component CSPMenuButton corresponding to event listeners that dispatch the custom events described above. These events invoke delegate class code (described above) for enabling communication between the Flash application and the automated testing platform. The following instructions may be added:

```
//Add the below code in the constructor of CSPMenuButton
popUp.addEventListener(MenuEvent.ITEM_CLICK,
CustomMenuClickHandler);
//Add the following Function to CSPMenuButton
Public function CustomMenuClickHandler (e: MenuEvent):void
{
  Var child: UIComponent = UIComponent(e.currentTarget);
  var rEvent:CustomMenuObjEvent = new
  CustomMenuObjEvent(CustomMenuObjEvent.ITEM_CLICK);
  rEvent.set_itemRenderer(child as Label, e.item.label);
  this.dispatchEvent(rEvent);
}
```

Automation tool 650 finally ensures that the delegate class described above is linked to (compiled with) the application code modules (containing the instructions forming the CSPMenuButton custom component) thereby ensuring that the modified code modules (containing the code described above) when executed in testing system 190Q facilitates automated testing of the Flash RIA (application instance 295A).

It may be appreciated that the addition of the above noted instructions enables testing interface 245 to send the custom events ITEM_CLICK and MOUSE_CLICK to the custom component CSPMenuButton, and also receive notifications when such events have been raised by the custom component. A tester wishing to more closely mimic the actions of a end-user, may use the above

According to another aspect of the present invention, automation tool 650 also adds unique values for an attribute of the components, thereby making the components uniquely addressable by the automated testing platform. In one embodiment, the value of either the automationName and/or the automationValue attributes is used by the testing platform to uniquely address the custom components of the RIA. Automation tool 650, accordingly, adds the above noted attributes (if not already present in the code modules) and inserts a corresponding unique value to each of the components defined by the code modules in code repository.

It may be appreciated that the unique values for each component may be generated in a known way, for example, by following a standard convention. In one embodiment, the standard convention of “<testingtool>_<mxml filename>_<nth ui component>” is used, where <testingtool> is a text indicating the automated testing platform, <mxml filename> is the name of the file in which the code is contained, and <nth ui component> is a sequential number assigned to each of the user interface components. Thus, according the above convention, for one of the components of the user interface components of the QTP platform noted above, unique values such as “qtp_automation_cspmenu_10”, etc. may be generated. In general, any approach convenient to both developer and tester can be used for generating the unique values.

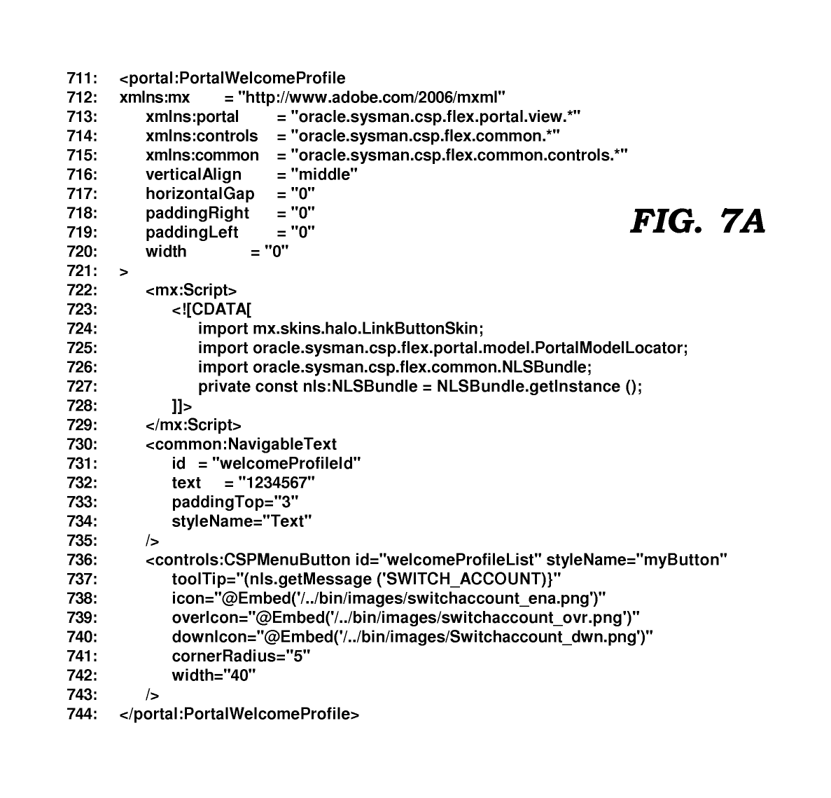

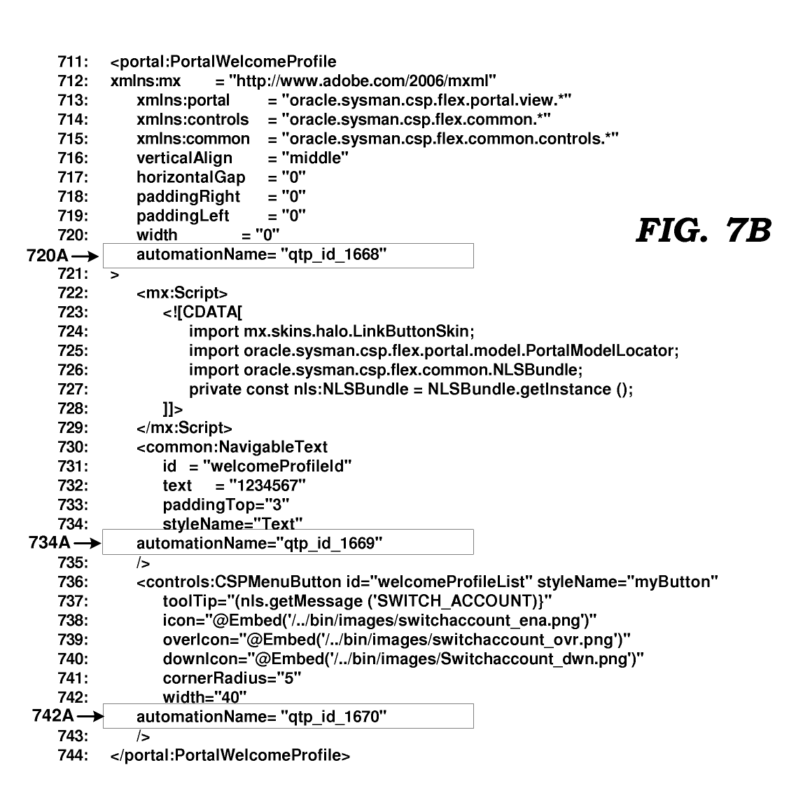

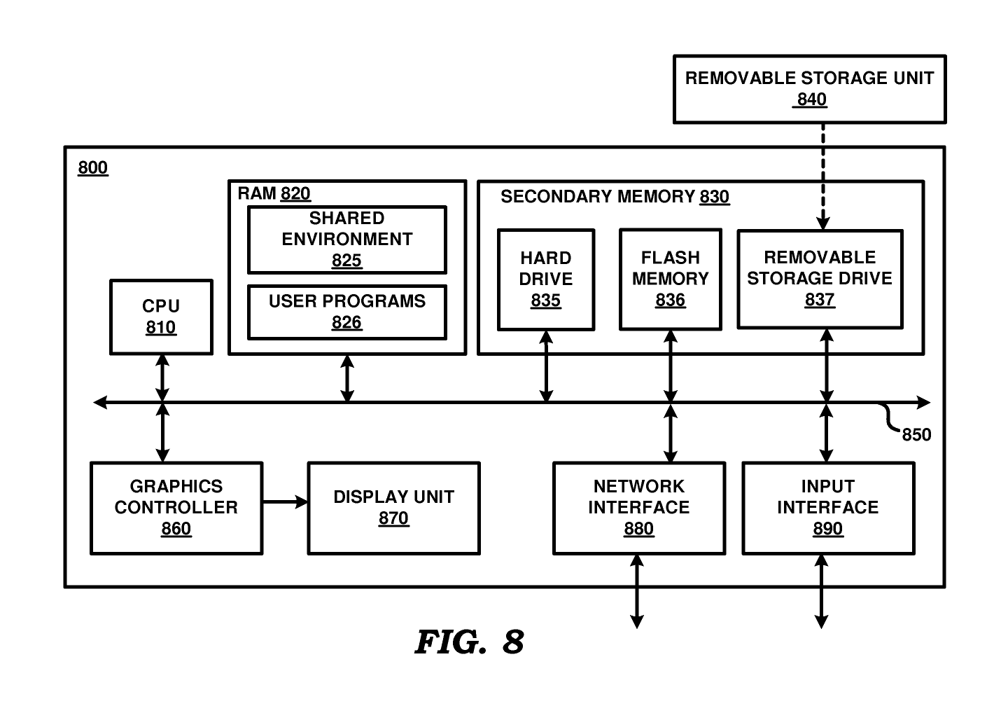

FIGS. 7A and 7B together illustrates the manner in which the components of a user interface provided by a Rich Internet Application (RIA) are made (uniquely) addressable in one embodiment. In particular, FIG. 7A depicts portions of code module of a RIA defining various components of the user interface, such as a welcome webpage (in lines 711-744), navigable text (in lines 730-735) and menu button (in lines 736-743). It may be observed that the components specified in FIG. 7A do not have any common attribute whose value can be used to (uniquely) address the components.

Automation tool 650, accordingly on receiving the code module of FIG. 7A, inserts a common attribute and a corresponding unique value for each component in the module to generate the modified module of FIG. 7B. Referring to FIG. 7B, lines 720A, 734A and 742A depict the common attribute “automationName” and corresponding unique values “qtp_id_1668”, “qtp_id_1669” and “qtp_id_1670” inserted by automation tool 650 corresponding to the components of the user interface defined in the code module of FIG. 7A. Thus, the components of the user interface of the RIA are made (uniquely) addressable by an automated testing platform (250).

Automation tool 650 may then compile the modified code modules (containing the added instructions and inserted data) along with the libraries required for supporting automated testing. In one embodiment, automation tool 650 includes instructions to ensure that the required libraries are loaded dynamically, based on the universal resource locator (URL) used to access the application.

Thus, in the web page (e.g., “CSP.html”) in which the Flash application/object is embedded, the line ‘mos.swf=“CSP”;’, where CSP represent the name of the object/SWF file to be executed is replaced with the following instructions (shown in Javascript like pseudo-code):

```
function getQueryVariable(variable)
{
  var atquery = window.location.search.substring(1);
  var atstr = atquery.split(“&”);
  (var i=0;i<atstr.length;i++)
  {
    var atvar = atstr[i].split(“=”);
    if (atvar[0] == variable){
        return atvar[1];
  }
}
var swfFileName= getQueryVariable(“automation”);
var requiredMajorVersion = 9;
var requiredMinorVersion = 0;
var requiredRevision = 124;
var mos = { };
if(swfFileName == “true”)
{
mos.swf = “runtimeloading”;
}
else
{
mos.swf = “CSP”;
}
```

It may be appreciated that the above instructions causes the “csp.swf” file to be executed (as an application instance) when the URL used to access contains only the name of the webpage (for example, when the URL is of the form “http://application_URL/CSP.html”) and the “runtimeloading.SWF” file to be executed when the URL has a query variable “automation” in it (e.g., when the URL is of the form “http://application_URL/CSP.html? automation=true”). Though not shown, the web page “CSP.html” is also modified by automation tool 650 to include instructions for loading the additional libraries required for facilitating automated testing of the RIA.

Automation tool 650 accordingly also generates the “runtimeloading.swf” by performing the steps described below:

a) Create an empty project named “runtimeloading” in Adobe Flex builder.

b) In the source directory of this project include following mxml file: flex_builder_install_dir/sdks/3.0.0/templates/automation-runtimeloading-files/runtimeloading.mxml

c) Compile this project by including the following automation libraries:

flex_builder_install_dir/sdks/3.0.0/frameworks/libs/qtp.swc

flex_builder_install_dir/sdks/3.0.0/frameworks/libs/automation.swc

flex_builder_install_dir/sdks/3.0.0/frameworks/libs/automation_agent.swc

d) This generates a runtimeloading.swf file in bin directory of this project.

It may be observed that the “runtimeloading.swf” is checked (by compilation) for working with the various libraries required for facilitating automated testing (and that are loaded later during execution, as noted above). Thus, automation tool 650 ensures that the libraries forming part of testing interface 245 (facilitating automated testing of a RIA) are included/executed along with the RIA.

It should be appreciated that the features described above can be implemented in various embodiments as a desired combination of one or more of hardware, executable modules, and firmware. The description is continued with respect to an embodiment in which various features are operative when the software instructions described above are executed.

### 11. Digital Processing System

FIG. 7 is a block diagram illustrating the details of digital processing system 700 in which various aspects of the present invention are operative by execution of appropriate software instructions. Digital processing system 700 may correspond to any system (such as server system 140A) executing automation tool 650.

Digital processing system 700 may contain one or more processors (such as a central processing unit (CPU) 710), random access memory (RAM) 720, secondary memory 730, graphics controller 760, display unit 770, network interface 780, and input interface 790. All the components except display unit 770 may communicate with each other over communication path 750, which may contain several buses as is well known in the relevant arts. The components of FIG. 7 are described below in further detail.

CPU 710 may execute instructions stored in RAM 720 to provide several features of the present invention. CPU 710 may contain multiple processing units, with each processing unit potentially being designed for a specific task. Alternatively, CPU 710 may contain only a single general-purpose processing unit.

RAM 720 may receive instructions from secondary memory 730 using communication path 750. RAM 720 is shown currently containing software instructions constituting shared environment 725 and/or user programs 726 (such as networking applications, database applications, etc.). Shared environment 725 contains utilities shared by user programs, and such shared utilities include operating system, device drivers, virtual machines, flow engine, etc., which provide a (common) run time environment for execution of user programs/applications.

Graphics controller 760 generates display signals (e.g., in RGB format) to display unit 770 based on data/instructions received from CPU 710. Display unit 770 contains a display screen to display the images defined by the display signals (such as the user interface shown in FIG. 3). Input interface 790 may correspond to a keyboard and a pointing device (e.g., touch-pad, mouse) and may be used to provide the user inputs required for several aspects of the present invention (such as those provided for interacting with the user interface shown in FIG. 3). Network interface 780 provides connectivity to a network (e.g., using Internet Protocol), and may be used to communicate with other connected systems (such as end-user systems 110A-110Z, data store 180, testing systems 190P-190R, etc.) of FIG. 1.

Secondary memory 730 may contain hard drive 735, flash memory 736, and removable storage drive 737. Secondary memory 730 may store the data and software instructions (for example, for performing the steps of FIGS. 4 and 5), which enable digital processing system 700 to provide several features in accordance with the present invention.

Some or all of the data and instructions may be provided on removable storage unit 740, and the data and instructions may be read and provided by removable storage drive 737 to CPU 710. Floppy drive, magnetic tape drive, CD-ROM drive, DVD Drive, Flash memory, removable memory chip (PCMCIA Card, EPROM) are examples of such removable storage drive 737.

Removable storage unit 740 may be implemented using medium and storage format compatible with removable storage drive 737 such that removable storage drive 737 can read the data and instructions. Thus, removable storage unit 740 includes a computer readable storage medium having stored therein computer software and/or data. However, the computer (or machine, in general) readable storage medium can be in other forms (e.g., non-removable, random access, etc.).

In this document, the term “computer program product” is used to generally refer to removable storage unit 740 or hard disk installed in hard drive 735. These computer program products are means for providing software to digital processing system 700. CPU 710 may retrieve the software instructions, and execute the instructions to provide various features of the present invention described above.

It should be understood that numerous specific details, relationships, and methods are set forth to provide a full understanding of the invention. For example, many of the functions units described in this specification have been labeled as modules/blocks in order to more particularly emphasize their implementation independence.

Reference throughout this specification to “one embodiment”, “an embodiment”, or similar language means that a particular feature, structure, or characteristic described in connection with the embodiment is included in at least one embodiment of the present invention. Thus, appearances of the phrases “in one embodiment”, “in an embodiment” and similar language throughout this specification may, but do not necessarily, all refer to the same embodiment.

Furthermore, the described features, structures, or characteristics of the invention may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the invention.

### 12. Conclusion

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

It should be understood that the figures and/or screen shots illustrated in the attachments highlighting the functionality and advantages of the present invention are presented for example purposes only. The present invention is sufficiently flexible and configurable, such that it may be utilized in ways other than that shown in the accompanying figures.

Further, the purpose of the following Abstract is to enable the Patent Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A method of testing of Rich Internet Applications (RIA), said method comprising:
receiving a plurality of code modules of a RIA from a plurality of developers, wherein said plurality of code modules are designed to provide a plurality of components of a user interface for said RIA, wherein said plurality of code modules are designed such that each of said plurality of components is not accessible to an automated testing platform when said RIA is executed in a framework operating in the context of a browser;
adding instructions to each of said plurality of code modules to generate a plurality of modified modules, wherein the added instructions are designed to cause said plurality of components to be made accessible to said automated testing platform when said RIA is executed in said framework in the context of said browser,
wherein said instructions are added using an automation tool after receiving each code module from the corresponding developer;
executing said plurality of modified modules in said framework operating in the context of said browser, whereby said plurality of components are accessible to said automated testing platform due to addition of said instructions; and
accessing data representing said plurality of components from said automated testing platform to check whether the performance of said RIA is according to an expected operation.

2. The method of claim 1, wherein said browser is designed to expose data representing said plurality of components to said automated testing platform if frameworks operating in the context of said browser are non-proprietary,
wherein said framework is a proprietary framework such that said plurality of components are represented by constructs that are unable to be interpreted by said browser to expose said data,
wherein said added instructions cause said data representing said constructs representing said plurality of components to be exposed to said automated testing platform.

3. The method of claim 2, wherein each of said components is a custom component created based on a set of components predefined in said proprietary framework.

4. The method of claim 2, wherein accessibility of said plurality of components by said automated testing platform requires a pre-defined set of libraries to be included in said RIA, said method further comprising:
compiling, by said automation tool, said plurality of modified modules along with said pre-defined set of libraries to generate a set of executable modules forming said RIA,
wherein said executing executes said RIA, including said pre-defined set of libraries, in said framework thereby providing access to said plurality of components.

5. A method of testing of Rich Internet Applications (RIA), said method comprising:
receiving a plurality of code modules of a RIA from a plurality of developers, wherein said plurality of code modules are designed to provide a plurality of components of a user interface for said RIA, wherein each component is designed to be addressable by an automated testing platform using a corresponding value for an attribute in the component;
inserting a unique value for said attribute of each of said plurality of components in said plurality of code modules to generate a plurality of modified modules,
wherein said inserting is performed by an automation tool after receiving each code module from the corresponding developer;
executing said plurality of modified modules in said framework operating in the context of said browser, whereby said plurality of components are addressable by said automated testing platform using the corresponding unique value; and
accessing data representing said plurality of components from said automated testing platform to check whether the performance of said RIA is according to an expected operation.

6. The method of claim 5, further comprising:
determining that said attribute is not specified in a first code module of said plurality of code modules,
wherein said inserting also inserts said attribute along with said unique value in said first code module.

7. The method of claim 6, wherein said unique value for said attribute of each of said plurality of components is generated according to a convention.

8. The method of claim 7, wherein said convention includes a name of said automated testing platform, a name of the file in which the corresponding code module is stored, and a sequential number assigned to each of said plurality of components.

9. A non-transitory machine readable medium storing one or more sequences of instructions for causing a system to testing of Rich Internet Applications (RIA), wherein execution of said one or more sequences of instructions by one or more processors contained in said system causes said system to perform the actions of:
receiving a plurality of code modules of a RIA from a plurality of developers, wherein said plurality of code modules are designed to provide a plurality of components of a user interface for said RIA, wherein said plurality of code modules are designed such that each of said plurality of components is not accessible to an automated testing platform when said RIA is executed in a framework operating in the context of a browser;
adding instructions to each of said plurality of code modules to generate a plurality of modified modules, wherein the added instructions are designed to cause said plurality of components to be made accessible to said automated testing platform when said RIA is executed in said framework in the context of said browser,
wherein said instructions are added using an automation tool after receiving each code module from the corresponding developer;
executing said plurality of modified modules in said framework operating in the context of said browser, whereby said plurality of components are accessible to said automated testing platform due to addition of said instructions; and
accessing data representing said plurality of components from said automated testing platform to check whether the performance of said RIA is according to an expected operation.

10. The machine readable medium of claim 9, wherein said browser is designed to expose data representing said plurality of components to said automated testing platform if frameworks operating in the context of said browser are non-proprietary,
wherein said framework is a proprietary framework such that said plurality of components are represented by constructs that are unable to be interpreted by said browser to expose said data,
wherein said added instructions cause said data representing said constructs representing said plurality of components to be exposed to said automated testing platform.

11. The machine readable medium of claim 10, wherein each of said components is a custom component created based on a set of components predefined in said proprietary framework.

12. The machine readable medium of claim 11, wherein accessibility of said plurality of components by said automated testing platform requires a pre-defined set of libraries to be included in said RIA, further comprising one or more instructions for:
compiling, by said automation tool, said plurality of modified modules along with said pre-defined set of libraries to generate a set of executable modules forming said RIA,
wherein said executing executes said RIA, including said pre-defined set of libraries, in said framework thereby providing access to said plurality of components.

13. The machine readable medium of claim 9, wherein each component in said plurality of components is designed to be addressable by said automated testing platform using a corresponding value for an attribute in the component, further comprising one or more instructions for:
inserting a unique value for said attribute of each of said plurality of components in said plurality of code modules to generate said plurality of modified modules,
wherein said inserting is performed by said automation tool after receiving each code module from the corresponding developer,
whereby said plurality of components are addressable by said automated testing platform using the corresponding unique value during said executing of said plurality of modified modules in said framework.

14. The machine readable medium of claim 13, further comprising one or more instructions for:
determining that said attribute is not specified in a first code module of said plurality of code modules,
wherein said inserting also inserts said attribute along with said unique value in said first code module.

15. The machine readable medium of claim 14, wherein said unique value for said attribute of each of said plurality of components is generated according to a convention.

16. The machine readable medium of claim 15, wherein said convention includes a name of said automated testing platform, a name of the file in which the corresponding code module is stored, and a sequential number assigned to each of said plurality of components.

17. A system comprising:
a testing system to execute an automated testing platform that enables testers to test Rich Internet Applications (RIA) executed in a framework operating in the context of a browser;
a plurality of developer systems to enable developers to create a plurality of code modules of a RIA, wherein said plurality of code modules are designed to provide a plurality of components of a user interface for said RIA, wherein said plurality of code modules are designed such that each of said plurality of components is not accessible to said automated testing platform when said RIA is execute in said framework on said testing system; and
an automation tool to add instructions to each of said plurality of code modules to generate a plurality of modified modules, wherein the added instructions are designed to cause said plurality of components to be made accessible to said automated testing platform when said RIA is executed in said framework on said testing system, wherein said automation tool adds instruction after receiving each code module from the corresponding developer,
said testing system further operable to:
execute said plurality of modified modules in said framework operating in the context of said browser, whereby said plurality of components are made accessible to said automated testing platform due to addition of said instructions; and
access data representing said plurality of components from said automated testing platform to check whether the performance of said RIA is according to an expected operation during testing of said RIA.

18. The system of claim 17, wherein said browser is designed to expose data representing said plurality of components to said automated testing platform if frameworks operating in the context of said browser are non-proprietary,
wherein said framework is a proprietary framework such that said plurality of components are represented by constructs that are unable to be interpreted by said browser to expose said data,
wherein said added instructions cause said data representing said constructs representing said plurality of components to be exposed to said automated testing platform.

19. The system of claim 18, wherein accessibility of said plurality of components by said automated testing platform requires a pre-defined set of libraries to be included in said RIA,
wherein said automation tool is further operable to compile said plurality of modified modules along with said pre-defined set of libraries to generate a set of executable modules forming said RIA,
wherein said testing tool executes said RIA, including said pre-defined set of libraries, in said framework thereby providing access to said plurality of components.

20. The system of claim 17, wherein each component in said plurality of components is designed to be addressable by said automated testing platform using a corresponding value for an attribute in the component,
wherein said automation tool is further operable to insert a unique value for said attribute of each of said plurality of components in said plurality of code modules to generate said plurality of modified modules,
whereby said plurality of components are addressable by said automated testing platform using the corresponding unique value during said executing of said plurality of modified modules in said framework on said testing system.
